(19) United States
(12) Patent Application Publication
(10) Pub. No.: US 2018/0093478 A1
(43) Pub. Date: Apr. 5, 2018

(54) LIQUID JETTING APPARATUS

(71) Applicant: BROTHER KOGYO KABUSHIKI KAISHA, Nagoya-shi (JP)

(72) Inventor: Hideki YAMAMOTO, Nagoya-shi (JP)

(73) Assignee: BROTHER KOGYO KABUSHIKI KAISHA, Nagoya-shi (JP)

(21) Appl. No.: 15/711,821

(22) Filed: Sep. 21, 2017

(30) Foreign Application Priority Data
Sep. 30, 2016 (JP) 2016-193699

(51) Int. Cl. B41J 2/165; G03G 21/16; B41J 2/175

(52) U.S. Cl. CPC B41J 2/16505; G03G 21/1633; B41J 2/17553; G03G 21/1842; G03G 2221/1687; G03G 2221/169; G03G 2215/067

(57) ABSTRACT

A liquid jetting apparatus includes: a liquid jetting unit configured to jet liquid; a casing including a tank storing part in which a tank containing the liquid to be supplied to the liquid jetting unit is stored, and having an opening through which the tank storing part communicates with an outside of the casing; a cover pivotally attached to the casing and selectively positioned in a closed position and an opened position; a moving member movably attached to the casing and including an engaging part configured to engage with the cover in the closed position to prevent pivoting of the cover; and a movement mechanism configured to move the moving member relative to the casing between an engagement position where the engaging part is engaged with the cover in the closed position and a release position where the pivoting of the cover is not prevented.

### CROSS REFERENCE TO RELATED APPLICATION

The present application claims priority from Japanese Patent Application No. 2016-193699 filed on Sep. 30, 2016, the disclosure of which is incorporated herein by reference in its entirety.

### BACKGROUND

### Field of the Invention

The present invention relates to a liquid jetting apparatus including a liquid jetting unit and a casing provided with a tank storing part in which a tank containing liquid to be supplied to the liquid jetting unit is stored.

### Description of the Related Art

There is conventionally known a recording apparatus having a casing in which a cartridge installing part (tank storing part) is formed. The casing has an opening that allows the cartridge installing part to communicate with the outside of the casing. The casing is provided with a cover pivotally attached thereto and selectively positioned in a closed position where the opening is closed and in an opened position where the opening is open. The cover is kept in the closed position by engaging a claw formed in an end surface of the cover with an engaging part formed in an edge of the opening of the casing.

### SUMMARY

When foreign matter, such as dust, enters the tank storing part from the outside of the casing through the opening, the foreign matter may adhere to a liquid inlet of a tank and/or enter a liquid channel leading from the tank to a liquid jetting unit. This may cause a failure in liquid jetting of the liquid jetting unit. Further, the liquid may leak from the tank storing part to the outside of the casing through the opening. The above recording apparatus has solved these problems by engaging the claw of the cover in the closed position with the engaging part of the casing. In that configuration, however, engagement between the claw of the cover and the engaging part of the casing may make the pivoting of the cover difficult.

An object of the present teaching is to provide a liquid jetting apparatus that can prevent the entrance of foreign matter and liquid leakage through an opening and facilitate pivoting of a cover.

According to an aspect of the present teaching, there is provided a liquid jetting apparatus, including: a liquid jetting unit configured to jet liquid; a casing including a tank storing part in which a tank containing the liquid to be supplied to the liquid jetting unit is stored, and having an opening through which the tank storing part communicates with an outside of the casing; a cover pivotally attached to the casing and selectively positioned in a closed position where the opening is closed and an opened position where the opening is open; a moving member movably attached to the casing and including an engaging part configured to engage with the cover in the closed position to prevent pivoting of the cover; and a movement mechanism configured to move the moving member relative to the casing between an engagement position where the engaging part is engaged with the cover in the closed position to prevent the pivoting of the cover and a release position where the pivoting of the cover is not prevented.

According to the aspect of the present teaching, engaging the engaging part with the cover in the closed position can prevent the entrance of foreign matter and liquid leakage through the opening. Further, allowing the movement mechanism to move the moving member from the engagement position to the release position facilitates the pivoting of the cover.

### BRIEF DESCRIPTION OF THE DRAWINGS

FIG. 1 is a perspective view of a printer according to a first embodiment of the present teaching.

FIG. 2 is a side view of a part, of a casing of the printer, provided with a cover.

FIG. 3A is a cross-sectional view taken along a line IIIA-IIIA of FIG. 2, and

FIG. 3B is a cross-sectional view depicting a state in which the cover has pivoted frontward from a state of FIG. 3A.

FIG. 4 is a perspective view of a printer according to a second embodiment of the present teaching.

FIG. 5A is a cross-sectional view of a printer according to a third embodiment of the present teaching that corresponds to FIG. 3A, and FIG. 5B is a cross-sectional view depicting a state in which the cover has pivoted frontward from a state of FIG. 5A.

### DESCRIPTION OF THE EMBODIMENTS

### First Embodiment

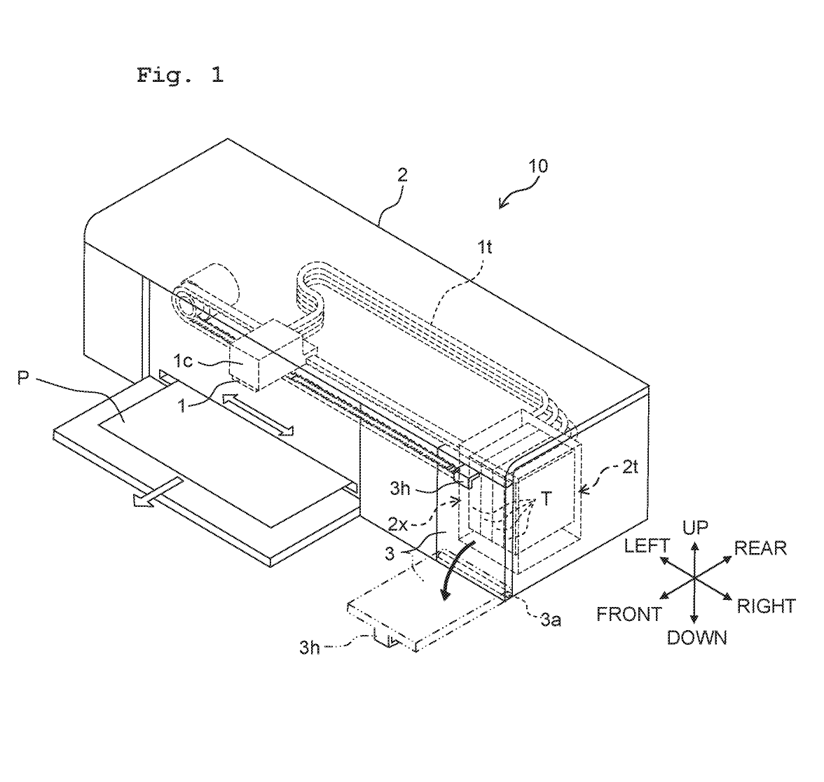

Referring to FIG. 1, an overall configuration of a printer 10 according to the first embodiment of the present teaching will be explained.

The printer 10 includes a head 1 and a casing 2.

The head 1 includes jetting ports (not depicted) through which inks are jetted. Any one of cyan, magenta, yellow, and black inks is jetted from each jetting port. The head 1 carried by a carriage 1c jets each ink from each jetting port while reciprocating in a left-right direction, thus forming an image on a sheet P that is conveyed from a rear side to a front side by a conveyance mechanism (not depicted).

The casing 2 includes a tank storing part 2t that stores four cartridge-type tanks T. Each of the tanks T contains the corresponding one of the four inks to be supplied to the head 1. The tanks T stored in the tank storing part 2t communicate with the head 1 via tubes 1t. A front side surface of the casing 2 is formed with an opening 2x that allows the tank storing part 2t to communicate with the outside of the casing 2.

A cover 3 is attached to a part of the casing 2 formed with the opening 2x. The cover 3 is pivotally attached to the casing 2 with a pivoting shaft 3a as a pivoting center. The cover 3 may selectively be positioned in a closed position (a position depicted by a solid line in FIG. 1) in which the opening 2x is closed with the cover 3 and in an opened position (a position depicted by a broken line in FIG. 1) in which the opening 2x is open. The pivoting shaft 3a, which is disposed below the opening 2x, extends in the left-right direction. A handle 3h is provided in an upper portion of an outer surface of the cover 3. A user may open and close the cover 3 by holding the handle 3h.

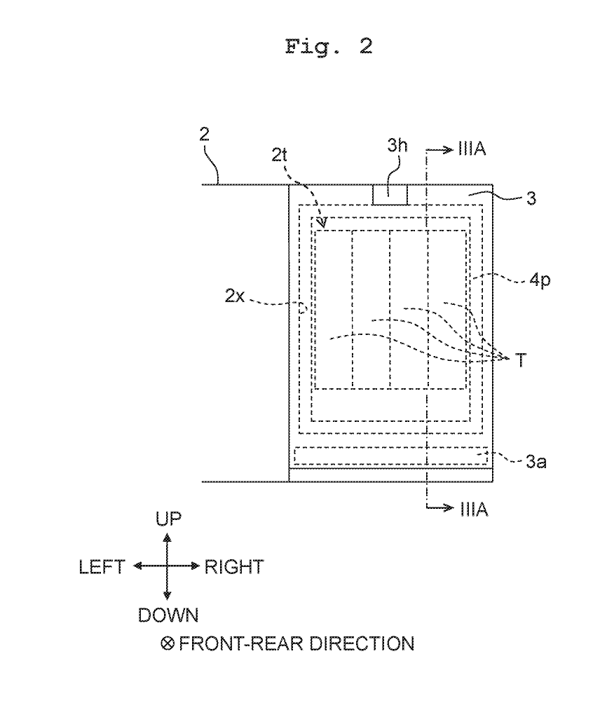

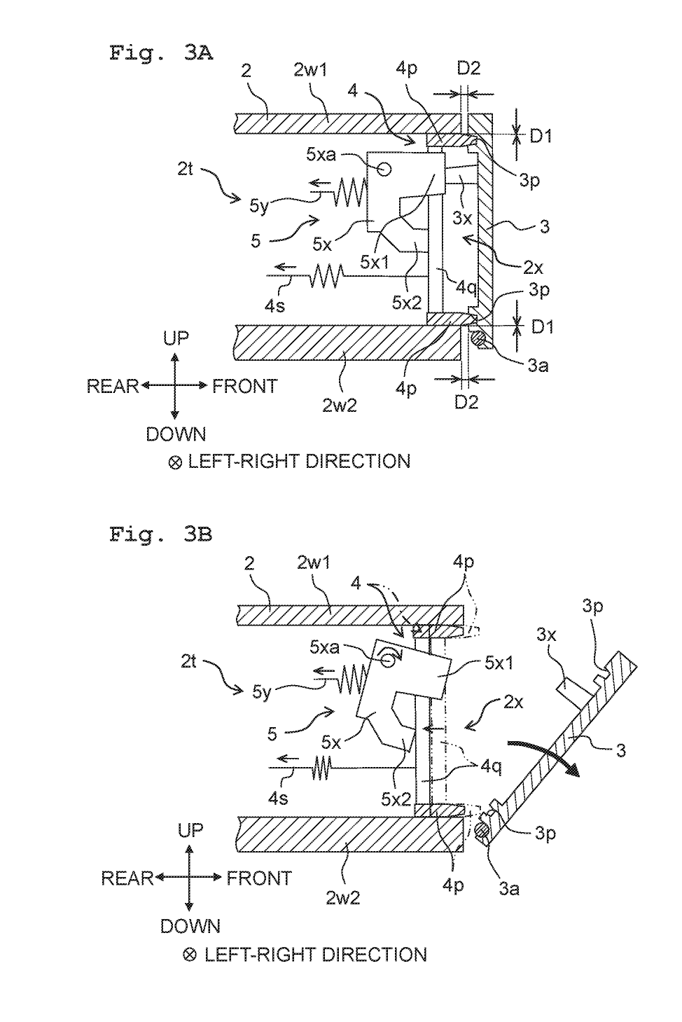

Referring to FIG. 2 to FIG. 3B, configurations of the casing 2 and the cover 3 will be explained in detail. FIGS. 3A and 3B omit an illustration of the tank T.

As depicted in FIG. 3A, a front end of the tank storing part 2t of the casing 2 is provided with a moving member 4. The moving member 4 includes a support part 4q extending in an up-down direction and a protrusion 4p supported by upper and lower ends of the support part 4q and protruding frontward from the support part 4q. The support part 4q is disposed at a right end of the tank storing part 2t in a state of being urged rearward by use of a spring 4s. As depicted in FIG. 2, the protrusion 4p surrounds the whole circumference of the opening 2x. The support part 4q is made from a rigid material (resin or the like) and the protrusion 4p is made from an elastic material (rubber or the like). The protrusion 4p is in tight contact with respective walls (i.e., an upper wall 2w1, lower wall 2w2, and left and right walls) defining the opening 2x of the casing 2 without space therebetween.

An inner surface of the cover 3, which faces inside of the casing 2 when the cover 3 is in the closed position, is formed with a recess 3p having a shape corresponding to the protrusion 4p and into which the protrusion 4p is to be fitted. As depicted in FIG. 3A, when the cover 3 is in the closed position, the protrusion 4p is fitted into the recess 3p. This keeps the cover 3 in the closed position to prevent pivoting of the cover 3. Namely, the moving member 4 includes the protrusion 4p as an engaging part that engages with the cover 3 in the closed position to prevent the pivoting of the cover 3. When the cover 3 is in the closed position, the protrusion 4p is fitted into the recess 3p such that the protrusion 4p is in tight contact with the respective walls defining the opening 2x. This airtightly covers the opening 2x to seal the tank storing part 2t in the casing 2. In that configuration, a gap D1 between the protrusion 4p and the casing 2 in the up-down direction is substantially zero, which is smaller than a gap D2 between the cover 3 and the casing 2 in a front-rear direction.

The casing 2 includes a movement mechanism 5 that moves the moving member 4 relative to the casing 2 in the front-rear direction. Similarly to the support part 4q, the movement mechanism 5 is disposed at the right end of the tank storing part 2t. The movement mechanism 5 includes a pivoting member 5x that pivots around a pivoting shaft 5xa extending in the left-right direction; and a spring 5y that urges the pivoting member 5x in a clockwise direction of FIG. 3A. The pivoting member 5x includes two protrusions 5x1 and 5x2 protruding frontward. The protrusion 5x1 is positioned on the left of the support part 4q. The protrusion 5x2, which overlaps in the left-right direction with the support part 4q, is constantly in contact with the support part 4q. As depicted in FIG. 3A, when the cover 3 is in the closed position, a front end surface of the protrusion 5x1 is in contact with an end surface of a protrusion 3x provided in the inner surface of the cover 3, and a front end surface of the protrusion 5x2 is in contact with a rear surface of the support part 4q.

Subsequently, opening and closing operations of the cover 3 will be explained.

When opening the cover 3 in the closed position, the user pivots the cover 3 from the closed position to the opened position (in a direction indicated by a thick arrow in FIG. 3B) while holding the handle 3h. In an early stage of this pivoting (when the cover 3 has started the pivoting from the closed position to the opened position), the protrusion 3x separates from the protrusion 5x1, which causes the pivoting member 5x to pivot in the clockwise direction of FIG. 3B by the aid of the urging force of the spring 5y. This moves the protrusion 5x2 rearward, moves the support part 4q rearward together with the protrusion 5x2 by the aid of the urging force of the spring 4s, and consequently moves the whole moving member 4 rearward. Accordingly, the moving member 4 moves from an engagement position depicted in FIG. 3A to a release position depicted in FIG. 3B. In other words, the movement mechanism 5 moves the moving member 4 from the engagement position to the release position in association with the pivoting of the cover 3 from the closed position to the opened position.

In the engagement position, the protrusion 4p is fitted into the recess 3p to prevent the pivoting of the cover 3. In the release position, the protrusion 4p is released from the recess 3p to allow the pivoting of the cover 3.

For example, when the user closes the cover 3 after disposing the tank T in the tank storing part 2t with the cover 3 kept in opened position, the user pivots the cover 3 from the opened position to the closed position (in a direction opposite to the thick arrow direction of FIG. 3B) while holding the handle 3h. In a latter stage of this pivoting (immediately before the cover reaches the closed position), the protrusion 3x makes contact with the protrusion 5x1 to push the protrusion 5x1 rearward. This causes the pivoting member 5x to pivot in a counterclockwise direction of FIG. 3B against the urging force of the spring 5y. The pivoting of the pivoting member 5x pushes the protrusion 5x2 frontward to move the support part 4q frontward against the urging force of the spring 4s. This moves the whole moving member 4 frontward from the release position depicted in FIG. 3B to the engagement position depicted in FIG. 3A. In other words, the movement mechanism 5 moves the moving member 4 from the release position to the engagement position in association with the pivoting of the cover 3 from the opened position to the closed position.

As described above, in the first embodiment, engaging the protrusion 4p with the cover 3 in the closed position prevents the entrance of foreign matter and ink leakage through the opening 2x (see FIG. 3A). Further, causing the movement mechanism 5 to move the moving member 4 from the engagement position (see FIG. 3A) to the release position (see FIG. 3B) facilitates the pivoting of the cover 3.

In the release position, the protrusion 4p is released from the recess 3p (see FIG. 3B). This facilitates the opening and closing operations of the cover 3.

The movement mechanism 5 moves the moving member 4 from the engagement position (see FIG. 3A) to the release position (see FIG. 3B) in association with the pivoting of the cover 3 from the closed position to the opened position. In that case, moving the moving member 4 from the engagement position to the release position independently of control of a controller facilitates the pivoting of the cover 3 without requiring a complex electrical configuration.

The movement mechanism 5 moves the moving member 4 from the release position (see FIG. 3B) to the engagement position (see FIG. 3A) in association with the pivoting of the cover 3 from the opened position to the closed position. In that case, moving the moving member 4 from the release position to the engagement position independently of control of the controller prevents the entrance of foreign matter and ink leakage through the opening 2x without requiring a complex electrical configuration.

The opening 2x is formed in a side surface of the casing 2 (see FIG. 1). This enables the user to exchange the cartridge-type tank T easily.

The movement mechanism 5 moves the moving member 4 in a direction orthogonal to a surface of the casing 2 formed with the opening 2x (an exemplary first direction, see FIGS. 3A and 3B). The moving member 4 can be moved by the simply-configured movement mechanism 5.

Fitting the protrusion 4p of the moving member 4 into the recess 3p of the cover 3 keeps the cover 3 in the closed position (see FIG. 3A). This reliably prevents the entrance of foreign matter and ink leakage through the opening 2x.

The protrusion 4p surrounds the whole circumference of the opening 2x (see FIG. 2). This reliably prevents the entrance of foreign matter and ink leakage through the opening 2x when the cover 3 is in the closed position.

When the moving member 4 is in the engagement position and the cover 3 is in the closed position (see FIG. 3A), the gap D1 between the protrusion 4p and the casing 2 in the up-down direction (a direction parallel to the surface of the casing 2 formed with the opening 2x, an exemplary second direction) is smaller than the gap D2 between the cover 3 and the casing 2 in the front-rear direction (the direction orthogonal to the surface of the casing 2 formed with the opening 2x). This reliably prevents the entrance of foreign matter and ink leakage through the opening 2x.

When the moving member 4 is in the engagement position, the protrusion 4p is in contact with the casing 2 (see FIG. 3A). This reliably prevents the entrance of foreign matter and ink leakage through the opening 2x.

The protrusion 4p is made from an elastic material, resulting in the configuration in which the protrusion 4p is in tight contact with the casing 2 without space therebetween.

### Second Embodiment

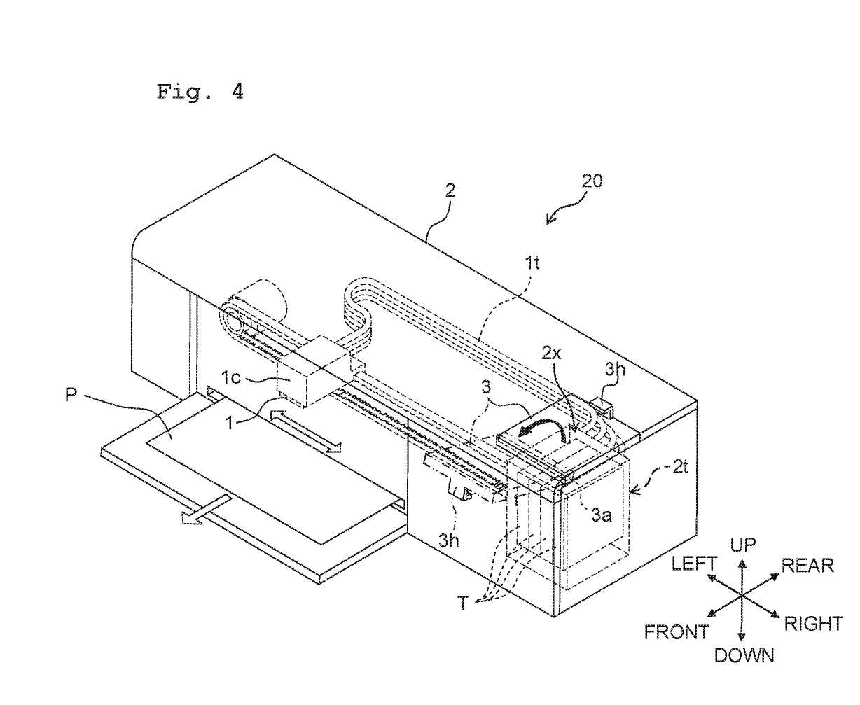

Subsequently, referring to FIG. 4, a printer 20 according to a second embodiment of the present teaching will be explained.

The printer 20 of the second embodiment is different from the printer 10 of the first embodiment in that the opening 2x is formed in an upper surface of the casing 2 rather than the side surface and that respective tanks T stored in the tank storing part 2t are of an ink replenishment-type rather than the cartridge-type.

In the second embodiment, the opening 2x is formed in the upper surface of the casing 2, and thus the movement mechanism 5 moves the moving member 4 in the up-down direction (the direction orthogonal to the surface of the casing 2 formed with the opening 2x).

Since the configuration of the printer 20 is the same as the printer 10 of the first embodiment except for the above-described features, the printer 20 can obtain the similar effects to those of the printer 1. Further, since the opening 2x is formed in the upper surface of the casing 2, the user can easily replenish the ink replenish-type tank T with ink.

### Third Embodiment

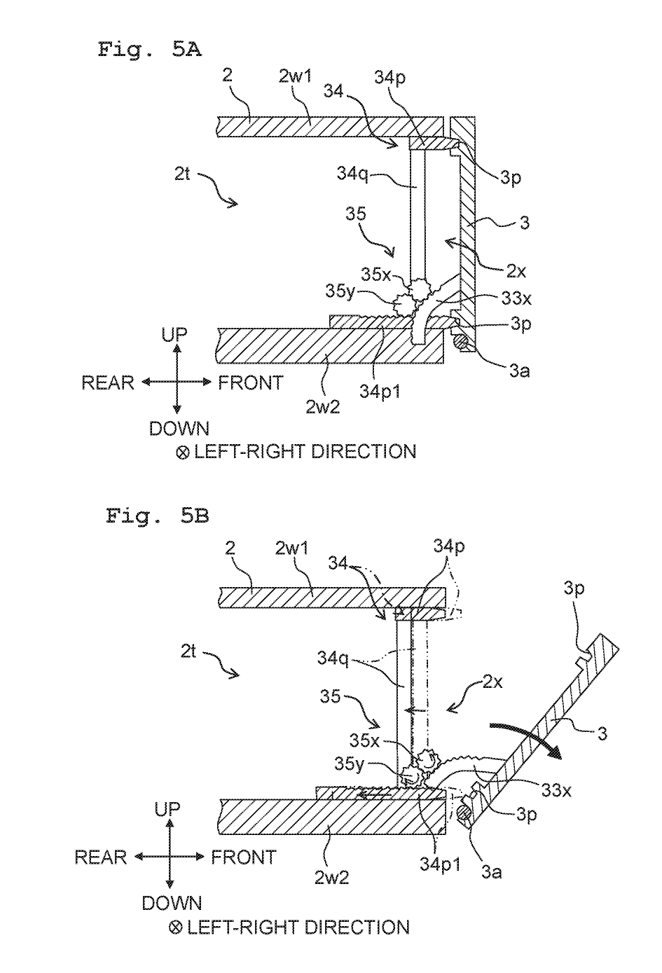

Subsequently, referring to FIGS. 5A and 5B, a printer according to a third embodiment of the present teaching will be explained. FIGS. 5A and 5B omit an illustration of the tank T.

The printer of the third embodiment has a moving member and a movement mechanism different from those of the printer 10 of the first embodiment.

In the third embodiment, a moving member 34 includes a support part 34q extending in the up-down direction and a protrusion 34p supported by upper and lower ends of the support part 34q and protruding frontward from the support part 34q. The support part 34q is disposed at a right end of the tank storing part 2t. The protrusion 34p surrounds the whole circumference of the opening 2x. A lower protrusion 34p1 of the protrusion 34p extending along a lower side of the opening 2x protrudes also rearward from the support part 34q. An upper surface of the lower protrusion 34p1 is formed with racks. The support part 34q is made from a rigid material (resin or the like) and the protrusion 34p is made from an elastic material (rubber or the like). The protrusion 34p is in tight contact with respective walls (i.e., the upper wall 2w1, lower wall 2w2, and left and right walls) defining the opening 2x of the casing 2 without space therebetween.

In the third embodiment, a movement mechanism 35 includes two gears 35x and 35y. The gears 35x and 35y are disposed at a right end of the tank storing part 2t. The gear 35x engages with the gear 35y and a rack member 33x provided in the inner surface of the cover 3. The gear 35y engages with the gear 35x and the racks provided in the lower protrusion 34p1.

Subsequently, the opening and closing operations of the cover 3 will explained.

When opening the cover 3, the user pivots the cover 3 from the closed position to the opened position (a direction indicated by a thick arrow in FIG. 5B) while holding the handle 3h. In that situation, the gear 35x rotates in a counterclockwise direction in FIG. 5B along with the movement of the rack member 33x. The rotation of the gear 35x is transmitted to the gear 35y, rotating the gear 35y in a clockwise direction in FIG. 5B. In association with the rotation of the gear 35y, the lower protrusion 34p1 moves rearward, thus moving the whole moving member 34 rearward. Accordingly, the moving member 34 moves from the engagement position depicted in FIG. 5A to the release position depicted in FIG. 5B. In other words, the movement mechanism 35 moves the moving member 34 from the engagement position to the release position in association with the pivoting of the cover 3 from the closed position to the opened position.

For example, when the user closes the cover 3 after disposing the tank T in the tank storing part 2t with the cover 3 kept in opened position, the user pivots the cover 3 from the opened position to the closed position (in a direction opposite to the thick arrow direction in FIG. 5B) while holding the handle 3h. In that situation, the gear 35x rotates in the clockwise direction in FIG. 5B along with the movement of the rack member 33x. The rotation of the gear 35x is transmitted to the gear 35y, rotating the gear 35y in the counterclockwise direction in FIG. 5B. In association with the rotation of the gear 35y, the lower protrusion 34p1 moves frontward, thus moving the whole moving member 34 frontward. Accordingly, the moving member 34 moves from the release position depicted in FIG. 5B to the engagement position depicted in FIG. 5A. In other words, the movement mechanism 35 moves the moving member 34 from the release position to the engagement position in association with the pivoting of the cover 3 from opened position to the closed position.

Since the configuration of the printer of the third embodiment is the same as the printer 10 of the first embodiment except for the above-described features, the printer of the third embodiment can obtain the similar effects to those of the printer 1.

In the above description, the embodiments of the present teaching have been explained. The present teaching, however, is not limited to those embodiments. Various design changes are possible without departing from the description of the appended claims.

The opening may be formed in any surface of the casing, for example, in a lower surface of the casing. The engaging part is not limited to the protrusion fitting into the recess of the cover, and it may be a recess into which a protrusion of the cover is to be fitted. The engaging part may include both the protrusion and the recess. The engaging part may not surround the whole circumference of the opening, and it may surround a part of the opening. The engaging part may not be made from the elastic material, and it may be made from a rigid material. When the moving member is in the engagement position, the engaging part may not be in contact with the casing. The moving member and the movement mechanism may not be disposed in the tank storing part, and they may be disposed in any position (e.g., the outside of the walls defining the opening of the casing). The movement mechanism may move the moving member in a direction different from the direction orthogonal to the surface of the casing formed with the opening (e.g., the direction parallel to the surface of the casing formed with the opening). The movement mechanism may not move the moving member in association with the pivoting of the cover, and it may move the moving member independently of the pivoting of the cover. The movement of the moving member between the engagement position and the release position and the pivoting of the cover may not be manually performed by the user, and they may be performed by control of the controller. The present teaching may be applicable to facsimile machines, copy machines, multifunction peripherals, and the like without limited to the printers.

What is claimed is:

1. A liquid jetting apparatus, comprising:
a liquid jetting unit configured to jet liquid;
a casing including a tank storing part in which a tank containing the liquid to be supplied to the liquid jetting unit is stored, and having an opening through which the tank storing part communicates with an outside of the casing;
a cover pivotally attached to the casing and selectively positioned in a closed position where the opening is closed and an opened position where the opening is open,
a moving member movably attached to the casing and including an engaging part configured to engage with the cover in the closed position to prevent pivoting of the cover; and
a movement mechanism configured to move the moving member relative to the casing between an engagement position where the engaging part is engaged with the cover in the closed position to prevent the pivoting of the cover and a release position where the pivoting of the cover is not prevented.

2. The liquid jetting apparatus according to claim 1, wherein in the release position, the engaging part is released from the cover in the closed position.

3. The liquid jetting apparatus according to claim 1, wherein the movement mechanism is configured to move the moving member from the engagement position to the release position in association with the pivoting of the cover from the closed position to the opened position.

4. The liquid jetting apparatus according to claim 1, wherein the movement mechanism is configured to move the moving member from the release position to the engagement position in association with the pivoting of the cover from the opened position to the closed position.

5. The liquid jetting apparatus according to claim 1, wherein the opening is formed in a side surface of the casing.

6. The liquid jetting apparatus according to claim 1, wherein the opening is formed in an upper surface of the casing.

7. The liquid jetting apparatus according to claim 1, wherein the movement mechanism is configured to move the moving member in a first direction orthogonal to a surface of the casing formed with the opening.

8. The liquid jetting apparatus according to claim 1, wherein the engaging part is at least one of a protrusion to be fitted in a recess formed in the cover and a recess into which a protrusion formed in the cover is to be fitted.

9. The liquid jetting apparatus according to claim 7, wherein the engaging part surrounds a whole circumference of the opening.

10. The liquid jetting apparatus according to claim 9, wherein, in a case that the moving member is in the engagement position and the cover is in the closed position, a gap between the engaging part and the casing in a second direction parallel to the surface of the casing formed with the opening is smaller than a gap between the cover and the casing in the first direction.

11. The liquid jetting apparatus according to claim 10, wherein, in a case that the moving member is in the engagement position, the engaging part is in contact with the casing.

12. The liquid jetting apparatus according to claim 11, wherein the engaging part is made from an elastic material.
